(19) United States
(12) Patent Application Publication
(10) Pub. No.: US 2009/0000984 A1
(43) Pub. Date: Jan. 1, 2009

(54) Catalytic Cracking Process For High Diesel Yield With Low Aromatic Content And/Or High Propylene Yield

(75) Inventors: Elbert Arjan De Graaf, Amsterdam (NL); Raymond Paul Fletcher, Den Haag (NL); King Yen Yung, Almere (NL); Erja Paivi Helena Rautiainen, Leusden (NL)

Correspondence Address: Albemarle Netherlands B.V.;Patent and Trademark Department, 451 Florida Street, Baton Rouge, LA, 70801, US

(73) Assignee: ALBEMARLE NETHERLANDS B.V., Amersfoort (NL)

(21) Appl. No.: 12/135,419

(22) Filed: Jun. 9, 2008

Related U.S. Application Data
(60) Provisional application No. 60/942,941, filed on Jun. 8, 2007.

(51) Int. Cl. C10G 51/02; C01B 39/02

(52) U.S. Cl. 208/74; 423/700

(57) ABSTRACT

Processes for maximizing low aromatics LCO yield and/or propylene yield in fluid catalytic cracking are disclosed. The processes employ catalytic compositions that comprise a predominantly basic material and little to no large pore zeolite.

The invention relates to a process for maximizing low aromatic diesel from FCC feedstocks.

Almost all catalytic cracking is presently carried out in a fluid catalytic cracking (FCC) process. In this process small particles of catalytic material are suspended in a lifting gas. The feedstock is sprayed onto catalyst particles through a nozzle. The feedstock molecules are cracked on the catalyst particles producing cracked products, which make up the lift gas carrying the catalyst particles through the reactor. The catalyst particles are separated from the reaction products, and sent to a stripping section where the catalyst is subjected to a severe steam treatment to remove as much of the hydrocarbon molecules as possible. After the stripper, the catalyst particles are transferred to a regenerator where coke that was formed during the reaction is burned off, and the catalyst is regenerated for further use. The foregoing is a simplified description of a single stage cracking process, which is by far the most widely used process.

The catalyst in a standard FCC process typically comprises a large pore acidic zeolite, such as Y-zeolite or a stabilized form of a Y-zeolite. Generally, the Y-zeolite is combined with a matrix material, which may be alumina or silica-alumina. The catalyst may further comprise components for improving its resistance against poisoning by metal contaminants of the feedstock, in particular nickel and vanadium. Other components may be present to capture sulfur from the feedstock. Primarily, the actual cracking process takes place on the acidic sites of the large pore zeolite.

The product of the FCC process is subsequently split into several fractions. Dry gas is a low molecular weight fraction that does not liquefy when compressed at ambient temperature (hence the term dry). The dry gas comprises H₂S, hydrogen, methane, ethane and ethene. The liquefied petroleum gas (LPG) fraction consists of compounds that are in the gas form at room temperature, but liquefy when compressed. This fraction comprises predominantly propane, propene, butane, and its mono- and di-olefins.

The gasoline fraction has a boiling point range of from about 40° C. to between about 165 to 221° C. The endpoint is varied to meet specific objectives of the refining process. The gasoline fraction forms the basis of commercial gasoline sold as a fuel for vehicles equipped with an Otto engine. One of the main requirements for the gasoline fraction is that it has as high an octane number as possible. Straight-chain hydrocarbons have a low octane number; branched-chain hydrocarbons have a higher octane number, with the octane number further increasing with the number of alkyl groups. Olefins have a high octane number, and aromatics have an even higher octane number.

The light cycle oil fraction, or LCO fraction, is the fraction having a boiling point above that of the gasoline fraction and lower than about 350° C. Hydrotreatment is typically required to convert the LCO to diesel fuel meeting governmental regulations. The quality of the LCO, in terms of its nitrogen content, its sulfur content and its aromatics content, determine the rate at which the LCO fraction may be blended into the feed that will be converted to diesel fuel in the hydrotreatment process. It is important for diesel fuel to have as high a cetane number as possible. Straight-chain hydrocarbons have a high cetane number; branched-chain hydrocarbons, olefins and aromatics have very low cetane numbers.

The product fraction having a boiling point above about 350° C. is referred to as “bottoms”. Although it is desirable to operate at the highest possible conversion, the composition of the product mix is adversely affected by operating at high conversion rates. For example, the coke yield increases as the conversion increases. Coke is a term describing the formation of carbon and pre-carbon deposits on the catalyst. Up to a point, the formation of coke is essential to the cracking process as it provides the energy for the endothermic cracking reaction. A high coke yield is, however, undesirable, because it results in a loss of hydrocarbon material and disruption of the heat balance as burning off of the coke produces more heat than the process requires. Under these conditions it may be necessary to release part of the produced heat, for example by providing a catalyst cooling device in the regenerator, or to operate the process in a partial combustion mode.

In general the most desirable fractions of the FCC products stream are the light olefins, the gasoline fraction, and the LCO fraction. The desired split between the last two is determined by the relative demand for commercial gasoline and diesel, and by the seasonal demand for heating fuel.

Because of the need for a high cetane number, it is desirable to keep the amount of aromatics in the light cycle oil fraction as low as possible. Because of their boiling points, a large portion of any aromatics formed will end up in the light cycle oil fraction. It is therefore desirable to minimize the amount of aromatics that is formed in the cracking process. The LCO from the thermal and catalytic cracking processes normally have a low cetane number. Typically the cetane number from a conventional FCC process ranges from about 20 to about 25. However, it has been increasingly desirable to drive the cetane number of the diesel pool above 50.

Lighter aromatics, such as benzene and toluene, become part of the gasoline fraction of the cracking product slate. Because of their high octane numbers, the aromatic components of gasoline might be considered desirable. However, because of a growing concern about the toxicity of aromatic compounds, it has become desirable to form a gasoline fraction that is low in aromatics content. The octane number of the gasoline pool of the refinery can be increased by alkylation of the butylenes and the isobutane streams from the FCC.

It is therefore desirable to develop a cracking process for the cracking of FCC feed stock whereby the formation of aromatics is reduced as compared to the conventional FCC processes. It is particularly desirable to provide a catalytic cracking process capable of producing a high yield light cycle oil fraction having a low aromatics content and higher cetane number as compared to conventional FCC processes.

One embodiment of the present invention comprises a fluid catalytic cracking process comprising: (a) contacting a FCC feed with a catalyst composition in a catalytic cracking stage under catalytic cracking conditions to produce cracked products; (b) separating at least a bottoms fraction from the cracked products; and (c) recycling at least a portion of the bottoms fraction to the catalytic cracking stage, wherein the catalyst composition comprises a predominantly basic material and less than about 15 wt % large pore zeolite, preferably less than about 10 wt %, more preferably less than about 5 wt %, even more preferably less than about 3 wt %, and most preferably substantially no large pore zeolite.

Another embodiment of the present invention comprises a fluid catalytic cracking process comprising: (a) contacting a FCC feed with a catalyst composition in a first catalytic cracking stage under catalytic cracking conditions to produce cracked products; (b) separating at least a bottoms fraction from the cracked products; (c) contacting at least a portion of the separated bottoms fraction with a catalyst composition under catalytic cracking conditions in a second fluid catalytic cracking stage, wherein the catalyst composition comprises a predominantly basic material and less than about 15 wt % large pore zeolite, preferably less than about 10 wt %, more preferably less than about 5 wt %, even more preferably less than about 3 wt %, and most preferably substantially no large pore zeolite.

Another embodiment of the present invention comprises a fluid catalytic cracking process comprising: (a) contacting a FCC feed with a first catalyst composition in a first catalytic cracking stage under catalytic cracking conditions to produce cracked products; (b) separating at least a bottoms fraction from the cracked products; (c) contacting at least a portion of the separated bottoms fraction with a second catalyst composition under catalytic cracking conditions in a second fluid catalytic cracking stage, the second fluid catalytic cracking stage being separate from the first fluid catalytic cracking stage wherein the first catalyst composition comprises a predominantly basic material and less than about 15 wt % large pore zeolite, preferably less than about 10 wt %, more preferably less than about 5 wt %, even more preferably less than about 3 wt %, and most preferably substantially no large pore zeolite.

Another embodiment of the present invention comprises a fluid catalytic cracking process comprising: (a) contacting a FCC feed with a catalyst composition in a catalytic cracking stage under catalytic cracking conditions to produce cracked products; (b) separating at least a bottoms fraction from the cracked products; (c) hydrogenating at least a portion of the bottoms fraction in the presence of a hydrogenating catalyst under hydrogenation conditions to form a hydrogenated bottoms product; and, (d) recycling at least a portion of the hydrogenated bottoms fraction to the catalytic cracking stage, wherein the catalyst composition comprises a predominantly basic material and less than about 15 wt % large pore zeolite, preferably less than about 10 wt %, more preferably less than about 5 wt %, even more preferably less than about 3 wt %, and most preferably substantially no large pore zeolite.

Another embodiment of the present invention comprises a fluid catalytic cracking process comprising: (a) contacting a FCC feed with a first catalyst composition in a first catalytic cracking stage under catalytic cracking conditions to produce cracked products; (b) separating at least a bottoms fraction from the cracked products; (c) hydrogenating at least a portion of the bottoms fraction in the presence of a hydrogenating catalyst under hydrogenation conditions to form a hydrogenated bottoms product; and, (d) contacting the hydrogenated bottoms product with a second catalytic cracking catalyst under catalytic cracking conditions in a second fluid catalytic cracking stage, the second fluid catalytic cracking stage being separate from the first fluid catalytic cracking stage wherein the first catalyst composition comprises a predominantly basic material and less than about 15 wt % large pore zeolite, preferably less than about 10 wt %, more preferably less than about 5 wt %, even more preferably less than about 3 wt %, and most preferably substantially no large pore zeolite.

The processes disclosed herein contemplate the use of a basic catalytic composition comprising a predominantly basic material to catalytically crack the FCC feedstock. The basic catalytic composition has basic sites and, optionally, acidic sites, with the proviso that, if that catalyst comprises both acidic and basic sites, the number of basic sites is significantly greater than the number of acidic sites.

While not being bound by any proposed theory, it is believed that a catalyst having basic sites catalyzes the cracking reaction via a radical, or one-electron, mechanism. This is the same mechanism as occurs in thermal cracking. The difference with thermal cracking is that the presence of a catalyst increases the rate of reaction, making it possible to operate at lower reaction temperatures as compared to thermal cracking. By contrast, the traditional FCC processes use an acidic material, commonly a large pore acidic zeolite, as the cracking catalyst. The acidic sites of the catalyst catalyze the cracking reaction via a two-electron mechanism. This mechanism favors the formation of high molecular weight olefins, which readily become cyclized to form cycloalkanes. The cycloalkanes in turn readily react to aromatics via hydrogen transfer catalyzed by the large pore zeolites. The amount and properties of large pore zeolites, such as USY, REY and others known in the art, determine the extent of this reaction. Even small amounts of large pore zeolites increase the activity of the catalyst system significantly, however at the cost of LCO quality. Therefore, the amount of large pore zeolite in the catalyst composition is preferably less than about 15 wt %, more preferably less than about 10 wt %, more preferably is less than about 5 wt %, even more preferably less than about 3 wt %. The most preferred catalyst composition is one that is substantially free of large pore zeolite.

The term “catalytic composition” as used herein refers to the combination of catalytic materials that is contacted with a FCC feedstock in a FCC process. The catalytic composition may consist of one type of catalytic particles, or may be a combination of different types of particles. For example, the catalytic composition may comprise particles of a main catalytic material and particles of a catalyst additive. The term “predominantly basic” is used herein to mean that less than about 40% of the material's sites are acidic. This is because the overall character of the material tends to become acidic under this condition. The presence of a material having acidic sites may be desirable in terms of improving the overall activity of the catalyst.

Suitable FCC feeds for the catalytic cracking process include hydrocarbonaceous oils boiling in the range of about 430° F. to about 1050° F. (220-565° C.), such as gas oil, heavy hydrocarbon oils comprising materials boiling above 1050° F. (565° C.); heavy and reduced petroleum crude oil; petroleum atmospheric distillation bottoms (atmospheric residue); petroleum vacuum distillation bottoms (vacuum residue); pitch, asphalt, bitumen, other heavy hydrocarbon residues; tar sand oils; shale oil; liquid products derived from coal liquefaction processes; and mixtures thereof.

The FCC feed is cracked under cracking conditions in the presence of a catalytic composition. The process conditions in the first fluid catalytic cracking stage include: (i) temperatures from about 480° C. to about 650° C., preferably from about 480° C. to about 600° C., and even more preferably between about 480° C. to about 500° C.; (ii) hydrocarbon partial pressures from about 10 to 40 psia (70−280 kPa); and, (iii) a catalyst to oil (wt/wt) ratio from about 3:1 to 40:1, preferably from about 10:1 to 30:1, where the catalyst weight is the total weight of the catalyst composition. Though not required, steam may be concurrently introduced with the feed into the reaction zone. The steam may comprise up to about 10 wt %, preferably between about 2 and about 3 wt. % of the feed.

The predominantly basic catalytic compositions used in the processes of the present invention provide a conversion of FCC feed stock of at least 10% at a catalyst-to-oil (CTO) ratio of 10 and a contact temperature below 700° C. Conversion, which is defined herein as (vol % dry gas)+(vol % LPG)+(vol % Gasoline)+(vol % Coke), is calculated as 100−(vol % Bottoms)−(vol % LCO). Preferably the conversion in the first fluid catalytic cracking stage is at least about 20%, more preferably at least about 30% and below about 70%, preferably below about 60%, and even more preferably below about 55%.

In the first fluid catalytic cracking stage, cracking is preferably performed at a low cracking temperature such that the LCO yield is maximized while its aromatics content is minimized. The aromatics content of the bottoms from the first stage is also low and can be easily cracked in a second stage, such as by recycling the bottoms or by feeding the bottoms to a second stage having a higher temperature and/or different catalyst than in the first stage. In this way the conversion of the FCC feed, the LCO yield and LCO cetane number are maximized.

The temperature in the first cracking stage should be kept as low as possible to reduce the formation of aromatics. In a conventional FCC Unit, stripping of the hydrocarbon vapors deteriorates as the cracking temperature is reduced because the stripping temperature is completely determined by the cracking temperature. If stripping becomes unacceptably low, hydrocarbon breakthrough to the regenerator occurs, which will cause temperature runaway and excessive catalyst deactivation. To enable a low cracking temperature without sacrificing stripping, facilities may be provided to increase stripping temperature, such as by routing some hot regenerated catalyst to the stripper bed.

As described above, it is possible to have a catalytic composition that has acidic sites in addition to its basic catalytic sites. It may even be desirable to provide acidic sites to increase the overall catalytic activity of the catalyst. If acidic sites are present, however, the number of basic sites must be significantly greater than the number of acidic sites (less than about 40% of the material's sites are acidic). Also, the acidic sites preferably are not present in the form of acidic large pore zeolitic material.

Methods for titrating the acidic sites and the basic sites of solid materials are described in “Studies in Surface Science and Catalysis, 51: New Solid Acids and Bases”, K. Tanabe, M. Misono, Y. Ono, H. Hattori, Kodansha Ltd. Tokyo (co-published by Kodansha Ltd. Tokyo and Elsevier Science Publishers B.V., Amsterdam) (hereinafter referred to as “Tanabe”).

The benchmark material is silica, which in the absence of additives or dopants, is considered “neutral” for purposes of the present invention. Any material having a more basic reaction to an indicator of the type described in Tanabe is in principle a basic material for purposes of the present invention.

As is clear from Table 2.4 of Tanabe, a solid material may have both basic and acidic sites. Basic materials suitable for the catalytic compositions of the present invention are those that have more basic sites than they possess acidic sites. The basic materials of the present invention may be mixed with acidic materials, provided that the sum total of basic sites of the composition is greater than the sum total of acidic sites.

Large pore acidic zeolites as are commonly used in conventional FCC catalysts have so many strong acidic sites that, when used in even small amounts in combination with a basic material, the resulting catalyst is predominantly acidic. The catalytic compositions of the present invention contain little large pore acidic zeolite, and preferably are substantially free of large pore acidic zeolite.

Materials suitable for use as catalytic compositions in the present invention include basic materials (both Lewis bases and Bronstedt bases), solid materials having vacancies, transition metals, and phosphates. It is desirable that the materials have a low dehydrogenating activity. Preferably, the catalytic compositions of the present invention are substantially free of components having a dehydrogenating activity. For example, it has been discovered, that compounds of several transition metals tend to have too strong a dehydrogenation activity to be useful in this context. Although they may possess the required basic character, the dehydrogenation activity of these materials results in an undesirably high coke yield and formation of too much aromatics. As a general rule, transition metals that tend to be present in or convert to their metallic state under FCC conditions have too high a dehydrogenation activity to be useful for the present purpose.

The basic material may be supported on a suitable carrier. For this purpose the basic material may be deposited on the carrier by any suitable method known in the art.

The carrier material may be acidic in nature. In many cases the basic material will cover the acidic sites of the carrier, resulting in a catalyst having the required basic character. Suitable carrier materials include the refractory oxides, in particular alumina, silica, silica-alumina, titania, zirconia, and mixtures thereof.

Suitable basic materials for use in the catalytic compositions of the present invention include compounds of alkali metals, compounds of alkaline earth metals, compounds of trivalent metals, compounds of transition metals, compounds of the Lanthanides, and mixtures thereof.

Suitable compounds include the oxides, the hydroxides and the phosphates of these elements.

A class of materials preferred as basic materials in the catalytic compositions of the present invention are mixed metal oxides, mixed metal hydroxides, and mixed metal phosphates. Cationic and anionic layered materials are suitable as precursors to mixed metal oxides.

Another class of preferred basic materials for the present invention are compounds of transition metals, in particular the oxides, hydroxides and phosphates. Preferred are compounds of transition metals that do not have a strong dehydrogenation activity. Examples of suitable materials include ZrO₂, Y₂O₃, and Nb₂O₅.

A preferred class of materials for use as basic catalytic compositions in the present invention are anionic clays, in particular hydrotalcite-like materials.

In hydrotalcite-like anionic clays the brucite-like main layers are built up of octahedra alternating with interlayers in which water molecules and anions, more particularly carbonate ions, are distributed.

The interlayers may contain anions such as NO₃⁻, OH⁻, Cl⁻, Br⁻, I⁻, SO₄²⁻, SiO₃²⁻, CrO₄²⁻, BO₃²⁻, MnO₄⁻, HGaO₃²⁻, HVO₄²⁻, C₄⁻, BO₃²⁻, pillaring anions such as V₁₀O₂₈⁶⁻, monocarboxylates such as acetate, dicarboxylates such as oxalate, alkylsulfonates such as laurylsulfonate.

“True” hydrotalcite, that is hydrotalcites having magnesium as the divalent metal and alumina as the trivalent metal, is preferred for use in the present invention.

The catalytic selectivity of a hydrotalcite-like material (including hydrotalcite itself) may be improved by subjecting the hydrotalcite to heat deactivation. A suitable method for heat deactivating a hydrotalcite material comprises treating the material in air or steam for several hours, for example five to 20 hours, at a temperature of from about 300 to about 900° C. Heating causes the layered structure to collapse and amorphous material to be formed. Upon continued heating, a doped periclase structure is formed, in which some of the Mg²⁺ sites are filled with Al³⁺. In other words, vacancies are formed, which have been found to improve the selectivity of the catalytic material.

Extreme heat treatment will cause this material to segregate into a periclase and a spinel structure. The spinel structure is inactive as a catalyst. Significant spinel formation has been observed after heating a hydrotalcite material for four hours at 900° C.

Another preferred class of basic materials is the aluminum phosphates.

The activity and the selectivity of the above-mentioned materials may be adjusted by doping these materials with another metal. In general, most transition metals are suitable dopants for use in this context. Notable exceptions include those transition metals that have a dehydrogenating activity, such as nickel, and the platinum group metals. Fe and Mo have also been found to be unsuitable.

Preferred dopants include metal cations from Groups IIb, IIIb, IVb of the Periodic Table of elements, and the rare earth metals. Specifically preferred dopants include La, W, Zn, Zr, and mixtures thereof.

As mentioned previously, the catalytic compositions of the present invention may further comprise an acidic material, provided that the overall character of the catalyst remains basic. The presence of a material having acidic sites may be desirable in terms of improving the overall activity of the catalyst.

Silica-magnesia is an example of a material having both basic and acidic sites. If more than about 40% of the sites are acidic the overall character of the material tends to become acidic.

Suitable materials having acidic sites include silica sol, metal doped silica sol, and nano-scale composites of silica with other refractory oxides. Acidic zeolites are not suitable for incorporation into the catalytic materials of the present invention, because the acidic character of acidic zeolites is so strong as to easily overwhelm the basic character of the catalyst. For this reason the catalytic compositions of the present invention comprise less than 3 wt % acidic zeolite, and are preferably substantially free of acidic zeolite.

A suitable method for preparing a catalyst having a high attrition resistance is described in U.S. Pat. No. 6,589,902 to Stamires et al., the disclosure of which are incorporated herein by reference.

The predominantly basic catalytic compositions of the present invention preferably have a relatively high specific surface area, to compensate for their activity being lower than that of conventional FCC catalysts. Preferably the predominantly basic catalytic compositions have a specific surface area as measured by the BET method after steam deactivation at 600° C. for 2 hours of at least 60 m²/g, preferably at least 90 m²/g.

In another embodiment, the process of the present invention utilizes a predominantly basic catalytic composition comprising a basic material and an intermediate and/or small pore zeolite, wherein the catalytic composition is substantially free of large pore zeolite. The catalytic composition may consist of one type of catalytic particles, or may be a combination of different types of particles. For example, the catalytic composition may comprise particles of a main catalytic material and particles of a catalyst additive. The combined composition should contain very little large pore zeolite, such as less than 15 wt %, preferably less than 10 wt %, more preferably less than 5 wt %, even more preferably less than 3 wt %, and most preferably substantially free of large pore zeolite.

Zeolites are crystalline aluminosilicates which have a uniform crystal structure characterized by a large number of regular small cavities that can be interconnected by a large number of even smaller rectangular channels. It was discovered that, by virtue of this structure consisting of a network of interconnected uniformly sized cavities and channels, crystalline zeolites are able to accept for absorption molecules having sizes below a certain well defined value whilst rejecting molecules of larger size, and for this reason they have come to be known as “molecular sieves.” This characteristic structure also gives them catalytic properties, especially for certain types of hydrocarbon conversions.

Intermediate and smaller pore zeolites are characterized by having an effective pore opening diameter of less than or equal to 0.7 nm, rings of 10 or fewer members and a Constraint Index of less than 31 and greater than 2. Intermediate and/or small pore zeolites useful in the present invention include the ZSM family of zeolites, including but not limited to ZSM-5, ZSM-11, ZSM-12, ZSM-23, ZSM-35, ZSM-38, ZSM-48, and other similar materials. Other suitable medium or smaller pore zeolites include ferrierite, erionite, and ST-5, ITQ, and similar materials. The crystalline aluminosilicate zeolite known as ZSM-5 is particularly described in U.S. Pat. No. 3,702,886; the disclosure of which is incorporated herein by reference. ZSM-5 crystalline aluminosilicate is characterized by a silica-to-alumina mole ratio of greater than 5 and more precisely in the anhydrous state by the general formula:

[0.9±0.2M_{2/n}O:Al₂O₃:>5SiO₂]

wherein M having a valence n is selected from the group consisting of a mixture of alkali metal cations and organo ammonium cations, particularly a mixture of sodium and tetraalkyl ammonium cations, the alkyl groups of which preferably contain 2 to 5 carbon atoms. The term “anhydrous” as used in the above context means that molecular water is not included in the formula. In general, the mole ratio of SiO₂ to Al₂O₃ for a ZSM-5 zeolite can vary widely. For example, ZSM-5 zeolites can be aluminum-free in which the ZSM-5 is formed from an alkali mixture of silica containing only impurities of aluminum. All zeolites characterized as ZSM-5, however, will have the characteristic X-ray diffraction pattern set forth in U.S. Pat. No. 3,702,886, regardless of the aluminum content of the zeolite.

Any known process may be employed to produce the intermediate and/or small pore zeolites useful in the present invention. Crystalline aluminosilicates in general have been prepared from mixtures of oxides including sodium oxide, alumina, silica and water. More recently, clays and coprecipitated aluminosilicate gels, in the dehydrated form, have been used as sources of alumina and silica in reaction systems.

The catalytic compositions of the present invention may contain between about 1 to about 75 wt % of at least one intermediate and/or small pore zeolite with greater than about 5 wt % being preferred, greater than about 10% being more preferred. The catalytic composition preferably comprises two distinct particles: one comprising a basic material and the other comprising the intermediate and/or small pore zeolite.

The catalytic compositions of the present invention preferably have a relatively high specific surface area, to compensate for their activity being lower than that of conventional FCC catalysts. Preferably the catalytic compositions have a specific surface area as measured by the BET method after steam deactivation at 600° C. for 2 hours of at least 60 m²/g, preferably at least 90 m²/g.

The cracking reactions deposits coke on the catalyst, thereby deactivating the catalyst. The cracked products are separated from the coked catalyst and at least a portion of the cracked products are conducted to a fractionator. The fractionator separates at least a bottoms fraction from the cracked products. The coked catalyst flows through the stripping zone where volatiles (strippable hydrocarbons) are stripped from the catalyst particles with a stripping material such as steam. Stripping preferably occurs under low severity conditions to retain a greater fraction of adsorbed hydrocarbons for heat balance. The stripped catalyst is then conducted to the regeneration zone where it is regenerated by burning coke on the catalyst in the presence of an oxygen containing gas, preferably air. Decoking restores catalyst activity and simultaneously heats the catalyst to about 650° C. to about 750° C. The hot catalyst is then recycled to the primary FCC riser reactor. Flue gas formed by burning coke in the regenerator may be treated for removal of particulates and for conversion of carbon monoxide.

In some embodiments of the present invention, at least a portion of the bottoms fraction is separated from the cracked product and then hydroprocessed to form a hydrogenated bottoms product. The terms hydroprocessing and hydrogenation are used broadly herein and include, for example, hydrogenation of aromatic species to substantial or complete saturation, hydrotreating, hydrocracking and hydrofining.

The bottoms fraction hydrogenation may occur in a hydroprocessing reactor under hydroprocessing conditions in the presence of an effective amount of a hydroprocessing or hydrogenation catalyst. As is known by those of skill in the art, the degree of hydroprocessing can be controlled through proper selection of catalyst and by optimizing operation conditions. Preferably, the hydroprocessing saturates a significant amount of the aromatic species. Objectionable species can also be removed by the hydroprocessing reactions. These species include non-hydrocarbyl species that may contain sulfur, nitrogen, oxygen, halides, and certain metals.

Hydroprocessing may be performed in one or more stages. The reaction occurs at a temperature ranging from about 100° C. to about 455° C. The reaction pressure preferably ranges from about 100 to about 3000 psig. The hourly space velocity preferably ranges from about 0.1 to 6 V/V/Hr, where V/V/Hr is defined as the volume of oil feed per hour per volume of catalyst. The hydrogen-containing gas is preferably added to establish a hydrogen charge rate ranging from about 500 to about 15,000 standard cubic feet per barrel (SCF/B). Actual conditions employed will depend on factors such as feed quality and catalyst.

Hydroprocessing conditions can be maintained using any of several types of hydroprocessing reactors. Trickle bed reactors are most commonly employed in petroleum refining applications with co-current downflow of liquid and gas phases over a fixed bed of catalyst particles. Moving bed reactors may be employed to increase metal and particulate tolerance in the hydroprocessor feed stream. Moving bed reactors generally include reactors wherein a captive bed of catalyst particles is contacted by upward-flowing liquid and treat gas. The catalyst bed may be slightly expanded by the upward flow or substantially expanded or fluidized by increasing flow rate via liquid recirculation (expanded bed or ebullating bed), using smaller size catalyst particles that are more easily fluidized (slurry bed), or both. Moving bed reactors utilizing downward-flowing liquid and gas may also be used because they enable on-stream catalyst replacement. In any case, catalyst can be removed from a moving bed reactor during onstream operation, enabling economic application when high levels of metals in the hydroprocessor feed would otherwise cause short run lengths in the alternative fixed bed designs.

Expanded or slurry bed reactors with upward-flowing liquid and gas phases enable economic operation with hydroprocessor feedstocks containing significant levels of particulate solids, by permitting long run lengths without risking shutdown from fouling. Such a reactor is especially beneficial in cases where the hydroprocessor feedstocks include solids greater than about 25 microns and where the hydroprocessor feedstocks contain contaminants that increase the propensity for accumulating foulants.

The catalyst used in the hydroprocessing stages can be any hydroprocessing catalyst(s) suitable for aromatic saturation, desulfurization, denitrogenation or any combination thereof. Suitable catalysts include monofunctional and bifunctional, monometallic and multimetallic noble metal-containing catalysts. Preferably, the catalyst comprises at least one Group VIII metal and at least one Group VI metal on an inorganic refractory support, a bulk metal oxide catalyst comprising at least one Group VIII metal and at least one Group VI metal, or mixtures thereof. For supported catalysts, any suitable inorganic oxide support material may be used for the hydroprocessing catalyst of the present invention. Preferred are alumina and silica-alumina, including crystalline alumino-silicate such as zeolite. The silica content of the silica-alumina support can be from 2-30 wt %, preferably 3-20 wt %, more preferably 5-19 wt %. Other refractory inorganic compounds may also be used, non-limiting examples of which include zirconia, titania, magnesia, and the like. The alumina can be any of the aluminas conventionally used for hydroprocessing catalysts. Such aluminas are generally porous amorphous alumina having an average pore size from 50-200 angstrom, preferably 70-150 angstrom, and a surface area from 50-450 m²/g.

The Group VIII and Group VI compounds are well known to those of ordinary skill in the art and are well defined in the Periodic Table of the Elements. The Group VIII metal may be present in an amount ranging from 2-20 wt %, preferably 4-12 wt % and may include Co, Ni, and Fe. The Group VI metals may be W, Mo, or Cr, with Mo preferred. The Group VI metal may be present in an amount ranging from 5-50 wt %, preferably from 20-30 wt %. The hydroprocessing catalyst preferably includes a Group VIII noble metal present in an amount ranging from 0-10 wt %, preferably 0.3-3.0 wt %. The Group VIII noble metal may include, but is not limited to, Pt, Ir, or Pd, preferably Pt or Pd, to which is generally attributed the hydrogenation function.

One or more promoter metals selected from metals of Groups IIIA, IVA, IB, VIB, and VIIB of the Periodic Table of the Elements may also be present. The promoter metal, can be present in the form of an oxide, sulfide, or in the elemental state. It is also preferred that the catalyst compositions have a relatively high surface area, for example, about 100 to 250 m²/g. All metals weight percents for the hydroprocessing catalyst are given on support. The term “on support” means that the percents are based on the weight of the support. For example, if a support weighs 100 g, then 20 wt % Group VIII metal means that 20 g of the Group VIII metal is on the support.

For bulk catalyst, any suitable bulk catalyst may be employed, such as the catalysts described in U.S. Pat. No. 6,162,350, the disclosure of which is herein incorporate by reference. Preferred bulk catalysts can be further described as a bulk mixed metal oxide which is preferably sulfided prior to use, and which is represented by the formula:

(Ni)_{b}(Mo)_{c}(W)_{d}O_{z}

wherein the molar ratio of b:(c+d) is 0.5/1 to 3/1, preferably 0.75/1 to 1.5/1, more preferably 0.75/1 to 1.25/1. The molar ratio of c:d is preferably >0.01/1, more preferably >0.1/1, still more preferably 1/10 to 10/1, still more preferably 1/3 to 3/1, most preferably substantially equimolar amounts of Mo and W, e.g., 2/3 to 3/2; and z=[2b+6(c+d)]/2. The essentially amorphous material has a unique X-ray diffraction pattern showing crystalline peaks at d=2.53 angstroms and d=1.70 angstroms.

The catalytic cracking catalyst of the second FCC stage comprises any conventional FCC catalyst. Suitable catalysts include: (a) amorphous solid acids, such as alumina, silica-alumina, silica-magnesia, silica-zirconia, silica-thoria, silica-beryllia, silica-titania, and the like; and (b) zeolite catalysts containing large pore zeolite. Suitable amounts of a large pore zeolite component in the catalytic cracking catalyst of the second FCC stage will generally range from about 1 to about 70 wt %.

### EXAMPLE

In the following example, the catalytic selectivity of a predominantly basic catalyst comprising hydrotalcite is evaluated in a Micro Fluid Simulation Test, the MST. The MST employs a fixed fluid bed micro-reactor, which is tuned to provide realistic results in line with those from commercial FCC Units. More details can be found in “A Microscale Simulation Test for Fluid Catalytic Cracking, P. O'Connor, M. B. Hartlkamp, ACS Symposium Series No. 411, 1989. The experiments were conducted at several cracking temperatures ranging from 480° C. to 560° C.

Vacuum gasoil and atmospheric residue were used as feedstocks.

TABLE 1
Characteristics of VGO and Atmospheric Residue

| | VGO | AR |
|---|---|---|
| IBP, ° C. | 228 | 231 |
| 5 WT %, ° C. | 292 | 320 |
| 10 WT % | 320 | 353 |
| 30 WT % | 374 | 423 |
| 50 WT % | 414 | 488 |
| 70 WT % | 457 | 604 |
| 90 WT % | 512 | 732 |
| FBP, ° C. | 561 | 761 |
| Saturates, wt % | 62.4 | 74.8 |
| Mono-aromatics, wt % | 17.0 | 9.3 |
| Di-aromatics, wt % | 11.1 | 6.2 |
| Di+-aromatics/Polars, wt % | 9.4 | 9.7 |
| Sulfur, ppm wt | 6400 | 2599 |
| Nitrogen, ppm wt | 1153 | 2643 |
| Conradson Carbon Residue, wt % | 0.14 | 5.27 |
| Density at 15° C. | 0.8998 | 0.8976 |

The hydrotalcite was prepared following the procedure described in U.S. Pat. No. 6,589,902. The Mg to Al ratio was 4:1. The hydrotalcite was calcined at 600° C. for one hour and used as catalyst in the experiments.

The reaction products were subjected to distillation. The LCO and HCO fractions were collected and analyzed for their aromatics content using two-dimensional gas chromatography. The dry gas, LPG and gasoline fractions were analyzed by GC. The coke yield was determined by analyzing the CO and CO₂ contents of the effluent upon regeneration of the catalyst under oxidizing conditions.

### BRIEF DESCRIPTION OF THE DRAWINGS

FIGS. 1-7 is a graphic description of yield structure in MST at different reaction temperature using HTC at Cat-to-Oil Ratio of 20 using crown VGO and Huabei Atmospheric Residue.

FIGS. 8-10 is a graphic description of the aromatic content of liquid products in MST at different reaction temperature using HTC at Cat-to-Oil Ratio of 20 using Crown VGO and Huabei Atmospheric Residue.

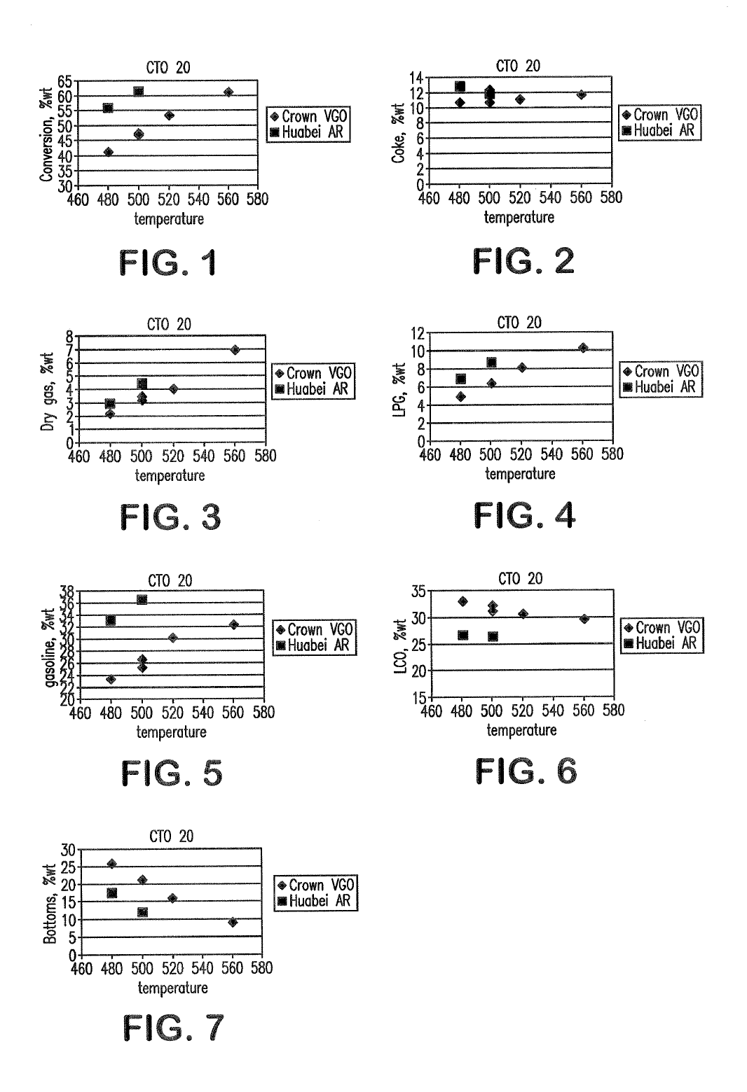

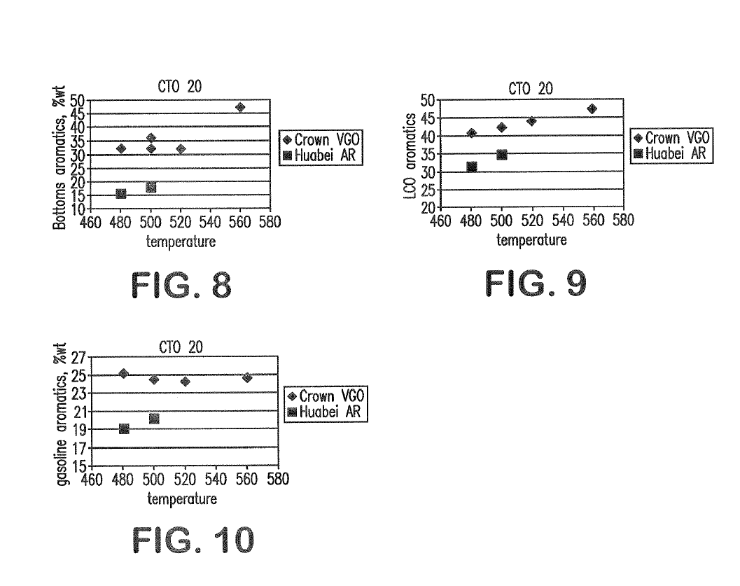

The yield structure is shown in FIGS. 1-7, while the aromatics content of gasoline, LCO and Bottoms are shown in FIGS. 8-10. The comparisons are made at a cat-to-oil of 20 wt/wt. In FIGS. 8-10, temperature is the catalyst bed temperature in ° C.; CTO is the catalyst/oil ratio in wt/wt; Dry gas is the amount of dry gas in the product stream (in wt %); LPG is the amount of liquefiable gas in the product stream (in wt %); Gasoline is the amount of product (in wt %) having a boiling point in the range above the boiling point of pentane to 221° C.; LCO (Light Cycle Oil) is the amount of product (in wt %) having a boiling point in the range of 221 to 350° C.; Bottoms is the amount of product (in wt %) having a boiling point above 350° C.; Coke is the amount of coke (in wt %) produced.

The results in FIGS. 1-7 show that the LCO yield is highest at low cracking temperature. Comparatively, the bottoms yield is highest at low cracking temperature. Note that the LCO yield is nearly 35 wt % for VGO feed at a low cracking temperature of 480° C. The corresponding LCO aromatics content is about 40 wt %. The bottoms yield is high, 25 wt %, while its aromatics content is relatively low at around 31 wt %. The low aromatics content of the bottoms permits it to be easily cracked in a second stage.

For the atmospheric residue, the LCO yield is about 26 wt %, the bottoms yield around 18 wt %, the LCO aromatics content is about 31 wt %, and the bottoms aromatics content about 15 wt % at the same cracking conditions.

Conventional commercial FCC cracking is conducted in the cracking temperature range of 500 to 560° C. using a conventional acidic type zeolite containing catalyst. This is best simulated in the MST by using a conventional large pore zeolite containing catalyst, a bed temperature of about 560° C. and a CTO of about 3 to about 4 wt %. The LCO yield is then less than 20 wt % and the LCO aromatics content above 80 wt %.

1. A fluid catalytic cracking process comprising:
(a) contacting a FCC feed with a catalyst composition in a catalytic cracking stage under catalytic cracking conditions to produce cracked products;
(b) separating at least a bottoms fraction from the cracked products; and
(c) recycling at least a portion of the bottoms fraction to the catalytic cracking stage;
wherein the catalyst composition comprises a predominantly basic material and less than about 15 wt % large pore zeolite.

2. The process of claim 1 wherein the catalyst composition comprises less than about 10 wt % large pore zeolite.

3. The process of claim 2 wherein the catalyst composition comprises less than about 5 wt % large pore zeolite.

4. The process of claim 3 wherein the catalyst composition comprises less than about 3 wt % large pore zeolite.

5. The process of claim 4 wherein the catalyst composition comprises substantially no large pore zeolite.

6. The process of claim 1 wherein the catalytic cracking conditions include a reaction temperature of between about 480 to about 900° C.

7. The process of claim 6 wherein the catalytic cracking conditions include a reaction temperature of between about 480 to about 600° C.

8. The process of claim 7 wherein the catalytic cracking conditions include a reaction temperature of between about 480 to about 500° C.

9. The process of claim 1 wherein the predominantly basic material is substantially free of components having a dehydrogenating activity or hydrogen transfer activity.

10. The process of claim 1 wherein the catalytic composition has sufficient catalytic activity to provide a conversion of FCC feedstock of at least about 30% at a cat to oil ratio of 10 and a reaction temperature below 600° C.

11. The process of claim 1 wherein the predominantly basic material is selected from the group consisting of compounds of alkali metals, compounds of alkaline earth metals, compounds of trivalent metals, compounds of transition metals, and mixtures thereof.

12. The process of claim 1 wherein the predominantly basic material is supported on a carrier material.

13. The process of claim 11, wherein the predominantly basic material is the oxide, the hydroxide or the phosphate of a transition metal, an alkali metal, an earth alkaline metal, or a transition metal, or a mixture thereof.

14. The process of claim 1 wherein the basic material is a mixed metal oxide.

15. The process of claim 14 wherein the basic material is a hydrotalcite.

16. The process claim 1 wherein the basic material is an aluminum phosphate.

17. The process of claim 1 wherein the basic material is doped with a metal cation.

18. The process of claim 17 wherein the dopant metal cation is selected from metals of Group IIb, Group IIIb, Group IVb, the rare earth metals, and mixtures thereof.

19. The process of claim 18 wherein the dopant metal is selected from the group consisting of La, Zn, Zr, and mixtures thereof.

20. The process of claim 12 wherein the carrier is a refractory oxide.

21. The process of claim 20 wherein the carrier is selected from alumina, silica, silica-alumina, titania, and mixtures thereof.

22. The process of claim 1 further comprising a material having acidic sites.

23. The process of claim 22 wherein the material having acidic sites is selected from the group consisting of silica sol, metal doped silica sol, and nano-scale composites of silica with other refractory oxides.

24. The process of claim 1 wherein the catalyst composition further comprises at least one intermediate or small pore zeolite.

25. The catalytic composition of claim 24 wherein the at least one intermediate or small pore zeolite is selected from the ZSM family of zeolites.

26. The catalytic composition of claim 25 wherein the ZSM family zeolite is ZSM-5.

27. A fluid catalytic cracking process comprising:
(a) contacting a FCC feed with a catalyst composition in a first catalytic cracking stage under catalytic cracking conditions to produce cracked products;
(b) separating at least a bottoms fraction from the cracked products; and
(c) contacting at least a portion of the separated bottoms fraction with a catalyst composition under catalytic cracking conditions in a second fluid catalytic cracking stage;
wherein the catalyst composition comprises a predominantly basic material and less than about 15 wt % large pore zeolite.

28. The process of claim 27 wherein the catalyst composition comprises less than about 10 wt % large pore zeolite.

29. The process of claim 28 wherein the catalyst composition comprises less than about 5 wt % large pore zeolite.

30. The process of claim 29 wherein the catalyst composition comprises less than about 3 wt % large pore zeolite.

31. The process of claim 30 wherein the catalyst composition comprises substantially no large pore zeolite.

32. The process of claim 27 wherein the catalytic cracking conditions include a reaction temperature of between about 480 to about 900° C.

33. The process of claim 32 wherein the catalytic cracking conditions include a reaction temperature of between about 480 to about 600° C.

34. The process of claim 33 wherein the catalytic cracking conditions include a reaction temperature of between about 480 to about 500° C.

35. The process of claim 27 wherein the predominantly basic material is substantially free of components having a dehydrogenating activity or hydrogen transfer activity.

36. The process of claim 27 wherein the catalytic composition has sufficient catalytic activity to provide a conversion of FCC feedstock of at least about 30% at a cat to oil ratio of 10 and a reaction temperature below 600° C.

37. The process of claim 27 wherein the predominantly basic material is selected from the group consisting of compounds of alkali metals, compounds of alkaline earth metals, compounds of trivalent metals, compounds of transition metals, and mixtures thereof.

38. The process of claim 27 wherein the predominantly basic material is supported on a carrier material.

39. The process of claim 37, wherein the predominantly basic material is the oxide, the hydroxide or the phosphate of a transition metal, an alkali metal, an earth alkaline metal, or a transition metal, or a mixture thereof.

40. The process of claim 27 wherein the basic material is a mixed metal oxide.

41. The process of claim 40 wherein the basic material is a hydrotalcite.

42. The process claim 27 wherein the basic material is an aluminum phosphate.

43. The process of claim 27 wherein the basic material is doped with a metal cation.

44. The process of claim 43 wherein the dopant metal cation is selected from metals of Group IIb, Group IIIb, Group IVb, the rare earth metals, and mixtures thereof.

45. The process of claim 44 wherein the dopant metal is selected from the group consisting of La, Zn, Zr, and mixtures thereof.

46. The process of claim 38 wherein the carrier is a refractory oxide.

47. The process of claim 46 wherein the carrier is selected from alumina, silica, silica-alumina, titania, and mixtures thereof.

48. The process of claim 27 further comprising a material having acidic sites.

49. The process of claim 46 wherein the material having acidic sites is selected from the group consisting of silica sol, metal doped silica sol, and nano-scale composites of silica with other refractory oxides.

50. The process of claim 27 wherein the catalyst composition further comprises at least one intermediate or small pore zeolite.

51. The catalytic composition of claim 50 wherein the at least one intermediate or small pore zeolite is selected from the ZSM family of zeolites.

52. The catalytic composition of claim 51 wherein the ZSM family zeolite is ZSM-5.

53. A fluid catalytic cracking process comprising:
(a) contacting a FCC feed with a first catalyst composition in a first catalytic cracking stage under catalytic cracking conditions to produce cracked products;
(b) separating at least a bottoms fraction from the cracked products; and
(c) contacting at least a portion of the separated bottoms fraction with a second catalyst composition under catalytic cracking conditions in a second fluid catalytic cracking stage, the second fluid catalytic cracking stage being separate from the first fluid catalytic cracking stage;
wherein the first catalyst composition comprises a predominantly basic material and less than about 15 wt % large pore zeolite.

54. The process of claim 53 wherein the catalyst composition comprises less than about 10 wt % large pore zeolite.

55. The process of claim 54 wherein the catalyst composition comprises less than about 5 wt % large pore zeolite.

56. The process of claim 55 wherein the catalyst composition comprises less than about 3 wt % large pore zeolite.

57. The process of claim 56 wherein the catalyst composition comprises substantially no large pore zeolite.

58. The process of claim 53 wherein the catalytic cracking conditions include a reaction temperature of between about 480 to about 900° C.

59. The process of claim 58 wherein the catalytic cracking conditions include a reaction temperature of between about 480 to about 600° C.

60. The process of claim 59 wherein the catalytic cracking conditions include a reaction temperature of between about 480 to about 500° C.

61. The process of claim 53 wherein the predominantly basic material is substantially free of components having a dehydrogenating activity or hydrogen transfer activity.

62. The process of claim 52 wherein the catalytic composition has sufficient catalytic activity to provide a conversion of FCC feedstock of at least about 30% at a cat to oil ratio of 10 and a reaction temperature below 600° C.

63. The process of claim 52 wherein the predominantly basic material is selected from the group consisting of compounds of alkali metals, compounds of alkaline earth metals, compounds of trivalent metals, compounds of transition metals, and mixtures thereof.

64. The process of claim 52 wherein the predominantly basic material is supported on a carrier material.

65. The process of claim 63, wherein the predominantly basic material is the oxide, the hydroxide or the phosphate of a transition metal, an alkali metal, an earth alkaline metal, or a transition metal, or a mixture thereof.

66. The process of claim 53 wherein the basic material is a mixed metal oxide.

67. The process of claim 66 wherein the basic material is a hydrotalcite.

68. The process claim 53 wherein the basic material is an aluminum phosphate.

69. The process of claim 53 wherein the basic material is doped with a metal cation.

70. The process of claim 69 wherein the dopant metal cation is selected from metals of Group IIb, Group IIIb, Group IVb, the rare earth metals, and mixtures thereof.

71. The process of claim 70 wherein the dopant metal is selected from the group consisting of La, Zn, Zr, and mixtures thereof.

72. The process of claim 64 wherein the carrier is a refractory oxide.

73. The process of claim 72 wherein the carrier is selected from alumina, silica, silica-alumina, titania, and mixtures thereof.

74. The process of claim 53 further comprising a material having acidic sites.

75. The process of claim 74 wherein the material having acidic sites is selected from the group consisting of silica sol, metal doped silica sol, and nano-scale composites of silica with other refractory oxides.

76. The process of claim 53 wherein the catalyst composition further comprises at least one intermediate or small pore zeolite.

77. The catalytic composition of claim 76 wherein the at least one intermediate or small pore zeolite is selected from the ZSM family of zeolites.

78. The catalytic composition of claim 77 wherein the ZSM family zeolite is ZSM-5.
